(19) United States
(12) Patent Application Publication
(10) Pub. No.: US 2025/0145199 A1
(43) Pub. Date: May 8, 2025

(54) Mobile, Adjustable Platform with Adjustable Wall Structures

(71) Applicant: Under Blind, Inc., Pittsburgh, PA (US)

(72) Inventor: Christopher J. Litwin, Pittsburgh, PA (US)

(21) Appl. No.: 18/837,777

(22) PCT Filed: Feb. 9, 2023
(86) PCT No.: PCT/US23/12670

§ 371 Date: Aug. 12, 2024

Related U.S. Application Data
(60) Provisional application No. 63/308,787, filed on Feb. 10, 2022.

(51) Int. Cl. B62B 1/20; B62B 1/26

(52) U.S. Cl. CPC B62B 1/208; B62B 1/268; B62B 2206/006

(57) ABSTRACT

A mobile platform may include: a base member; at least one wheel arrangement including at least one wheel, the at least one wheel arrangement detachably mounted to the base member; a plurality of adjustable support members configured to support the base member on a surface; and a plurality of panels extending about the base member. The plurality of panels may be transitionable relative to the base member between an upright position and an unfolded position, and the at least one locking mechanism may be is configured to lock the plurality of panels in either the upright position or the unfolded position.

### CROSS REFERENCE TO RELATED APPLICATION

This application claims priority to U.S. Provisional Patent Application No. 63/308,787 filed Feb. 10, 2022, the disclosure of which is hereby incorporated by reference in its entirety.

### BACKGROUND OF THE INVENTION

### Field of the Invention

This disclosure relates generally to a mobile and adjustable arrangement capable of transporting equipment and materials across open terrain and transforming into an adjustable support structure to allow an individual to use or engage the transported equipment and materials.

### Description of Related Art

Portable carriers such as wheelbarrows are typically used by individuals to carry materials or equipment over uneven or rugged terrain. The arrangement of a conventional wheelbarrow is suitable to handle this kind of travel, but it severely limits how much can be transported. While a wheelbarrow can move materials over a rugged terrain, there is still no guarantee that this rugged terrain can provide a suitable location in which a person can do work with the material transported by the wheelbarrow. This can cause problems for construction workers and outdoorsmen who must work in remote locations or places off of the beaten path.

Accordingly, a need exists for an apparatus that can both transport materials over various terrains and create or support a stable and level work surface at a location some distance away from what one would typically consider a suitable construction or work site or hunting location.

### SUMMARY OF THE INVENTION

The present disclosure is directed to a mobile platform. In one embodiment or aspect of the present disclosure, the mobile platform may include a base member; at least one wheel arrangement including at least one wheel, the at least one wheel arrangement detachably mounted to the base member; a plurality of panels extending about the base member; and at least one locking mechanism. The plurality of panels may be transitionable relative to the base member between an upright position and an unfolded position, and the at least one locking mechanism may be configured to lock the plurality of panels in either the upright position or the unfolded position. The plurality of panels and the base member may define a storage surface area, and when the panels are in the upright position, the storage surface area is smaller than when the panels are in the unfolded position. When the plurality of panels are in the upright position, the plurality of panels and the base member define a storage volume.

In another embodiment or aspect, the at least one locking mechanism may include at least one locking bracket and a plurality of receiving slots located on an outer surface of the plurality of panels, and the plurality of receiving slots may be configured to receive the at least one locking bracket therein. The plurality of receiving slots may include a first pair of receiving slots and a second pair of receiving slots. The first pair of receiving slots are configured to receive the at least one locking bracket when the panels are in the upright position, and the first pair of receiving slots are configured to receive the at least one locking bracket when the panels are in the upright position. A first receiving slot of the first pair of receiving slots may be located on a first panel, and a second receiving slot of the first pair of receiving slots may be located on a second panel adjacent to the first panel.

In another embodiment or aspect, a first receiving slot of the second pair of receiving slots may be located on the first panel below the first receiving slot of the first pair of receiving slots, and the second receiving slot of the second pair of receiving slots is located on the second panel below the second receiving slot of the first pair of receiving slots. The plurality of panels may include four panels, and the at least one bracket may include four brackets. Each of the four panels may include the first receiving slot of the first pair of receiving slots and the first receiving slot of the second pair of receiving slots proximate a first end of the panel and the second receiving slot of the first pair of receiving slots and the second receiving slot of the second pair of receiving slots proximate a second end of the panel, and the second end may be located opposite the first end. Each of the brackets may be configured to be received in the first pair of receiving slots or the second pair of receiving slots located on adjacent panels.

In another embodiment or aspect, the at least one locking bracket may include a bar, first leg extending from a first end of the bar, and a second leg extending from a second end of the bar opposite the first end. The first leg and the second leg may be configured to be received within corresponding receiving slots of the first and second pairs of receiving slots. The at least one locking bracket may include a detent and one of the first pair of receiving slots and one of the second pair of receiving slots each comprise a key configured to engage with the detent to lock the panels in the upright position or the unfolded position.

In another embodiment or aspect, the at least one locking mechanism may include at least one tube extending along a portion of the length of the panel; at least one base member connected to a panel and slidable along a length of the panel and a length of the at least one tube, the at least one base member being rotatable so that the panel can move between the upright position and the unfolded position. The at least one base member may be connected to a panel and slidable along a length of the panel and a length of the at least one tube, the at least one base member being rotatable so that the panel can move between the upright position and the unfolded position. The at least one base member may be configured to frictionally engage with the at least one tube, so that when the at least one base member is frictionally engaged with the at least one tube, the panel is locked in the upright position or the unfolded position, and when the at least one base member is not frictionally engaged with the at least one tube, the at least one base member is rotatable so that the panel can move between the upright position and the unfolded position.

In another embodiment or aspect, the at least one locking mechanism may further include a rod extending along the length of the panel. The at least one tube may extend about a portion of the rod, and the at least one base member may be slidable along the rod and the at least one tube. The at least one tube may include a plurality of tubes, each extending about a portion of the rod. The at least one base member may include a plurality of base members, each corresponding to one of the plurality of tubes. One locking mechanism may be provided for each of the plurality of panels. The rod and the at least one tube may share an axis along the length of the panel. The portion of the at least one base member that is configured to frictionally engage with the at least one tube shares the axis with the rod and the at least one tube. The at least one base member may include a stanchion extending perpendicular from the at least one tube and connected to the panel. The at least one tube may include a connector configured to connect the at least one tube to the base. End pieces may extend from the base, and the rod may extend between the end pieces. The end pieces may extend from opposing ends of the base.

In some embodiments or aspects, the present disclosure may be characterized by one or more of the following numbered clauses:

Clause 1: A mobile platform comprising: a base member; at least one wheel arrangement comprising at least one wheel, the at least one wheel arrangement detachably mounted to the base member; a plurality of panels extending about the base member; and at least one locking mechanism, wherein the plurality of panels are transitionable relative to the base member between an upright position and an unfolded position, and wherein the at least one locking mechanism is configured to lock the plurality of panels in the upright position and the unfolded position.

Clause 2. The mobile platform of clause 1, wherein the plurality of panels and the base member define a storage surface area, and wherein, when the panels are in the upright position, the storage surface area is smaller than when the panels are in the unfolded position.

Clause 3. The mobile platform of clause 1 or 2, wherein, when the plurality of panels are in the upright position, the plurality of panels and the base member define a storage volume.

Clause 4. The mobile platform of any of clauses 1-3, wherein the at least one locking mechanism comprises at least one locking bracket and a plurality of receiving slots located on an outer surface of the plurality of panels, the plurality of receiving slots being configured to receive the at least one locking bracket therein.

Clause 5. The mobile platform of any of clauses 1-4, wherein the plurality of receiving slots comprise a first pair of receiving slots and a second pair of receiving slots, wherein the first pair of receiving slots are configured to receive the at least one locking bracket when the panels are in the upright position, and wherein the second pair of receiving slots are configured to receive the at least one locking bracket when the panels are in the unfolded position.

Clause 6. The mobile platform of any of clauses 1-5, wherein a first receiving slot of the first pair of receiving slots is located on a first panel, and a second receiving slot of the first pair of receiving slots is located on a second panel adjacent to the first panel.

Clause 7. The mobile platform of any of clauses 1-6, wherein a first receiving slot of the second pair of receiving slots is located on the first panel below the first receiving slot of the first pair of receiving slots, and the second receiving slot of the second pair of receiving slots is located on the second panel below the second receiving slot of the first pair of receiving slots.

Clause 8. The mobile platform of any of clauses 1-7, wherein the plurality of panels comprises four panels and the at least one bracket comprises four brackets, wherein each of the four panels include the first receiving slot of the first pair of receiving slots and the first receiving slot of the second pair of receiving slots proximate a first end of the panel and the second receiving slot of the first pair of receiving slots and the second receiving slot of the second pair of receiving slots proximate a second end of the panel, the second located opposite the first end, and wherein each of the brackets are configured to be received in the first pair of receiving slots or the second pair of receiving slots located on adjacent panels.

Clause 9. The mobile platform of any of clauses 1-8, wherein the at least one locking bracket comprises a bar, first leg extending from a first end of the bar, and a second leg extending from a second end of the bar opposite the first end, and wherein the first leg and the second leg are configured to be received within corresponding receiving slots of the first and second pairs of receiving slots.

Clause 10. The mobile platform of any of clauses 1-9, wherein the at least one locking bracket comprises a detent and one of the first pair of receiving slots and one of the second pair of receiving slots each comprise a key configured to engage with the detent to lock the panels in the upright position or the unfolded position.

Clause 11. The mobile platform of any of clauses 1-10, wherein the at least one locking mechanism comprises: at least one tube extending along a portion of the length of the panel; at least one base member connected to a panel and slidable along a length of the panel and a length of the at least one tube, the at least one base member being rotatable so that the panel can move between the upright position and the unfolded position, and wherein the at least one base member is configured to frictionally engage with the at least one tube, so that when the at least one base member is frictionally engaged with the at least one tube, the panel is locked in the upright position or the unfolded position, and when the at least one base member is not frictionally engaged with the at least one tube, the at least one base member is rotatable so that the panel can move between the upright position and the unfolded position.

Clause 12. The mobile platform of any of clauses 1-11, wherein the at least one locking mechanism further comprises a rod extending along the length of the panel, wherein the at least one tube extends about a portion of the rod, wherein the at least one base member is slidable along the rod and the at least one tube.

Clause 13. The mobile platform of any of clauses 1-12, wherein the at least one tube comprises a plurality of tubes, each extending about a portion of the rod, wherein the at least one base member comprises a plurality of base members, each corresponding to one of the plurality of tubes.

Clause 14. The mobile platform of any of clauses 1-13, wherein one locking mechanism is provided for each of the plurality of panels.

Clause 15. The mobile platform of any of clauses 1-14, wherein the rod and at least one tube share an axis extending along the length of the panel.

Clause 16. The mobile platform of any of clauses 1-15, wherein the portion of the at least one base member that is configured to frictionally engage with the at least one tube shares the axis with the rod and the at least one tube.

Clause 17. The mobile platform of any of clauses 1-16, wherein the at least one base member comprises a stanchion extending perpendicular from the at least one tube and connected to the panel.

Clause 18. The mobile platform of any of clauses 1-17, wherein the at least one tube comprises a connector configured to connect the at least one tube to the base.

Clause 19. The mobile platform of any of clauses 1-18, further comprising end pieces extending from the base, wherein the rod extends between the end pieces.

Clause 20. The mobile platform of any of clauses 1-19, wherein the end pieces extend from opposing ends of the base.

### BRIEF DESCRIPTION OF THE DRAWINGS

FIG. 1 is a perspective view of a mobile, adjustable platform in the transport position, with panel walls locked in an upright position according to one embodiment or aspect of the present disclosure;

FIG. 2 is a perspective view of a locking mechanism of the mobile, adjustable platform of FIG. 1 with the panel walls in the upright position;

FIG. 3 is an exploded view of the locking mechanism of FIG. 2;

FIG. 4 is an exploded view of the locking mechanism of FIG. 2 with the panels in a downward position;

FIG. 5 is a perspective view of the mobile, adjustable platform of FIG. 1 with the panel walls locked in the downward position;

FIG. 6 is a perspective view of the mobile, adjustable platform of FIG. 1 with the panel walls locked in the downward position and materials placed on the platform;

FIG. 7 is a perspective view of the mobile, adjustable platform of FIG. 1 in the support position, with the panel walls locked in the downward position and materials placed on the platform;

FIG. 8 is a perspective view of a mobile, adjustable platform according to another embodiment or aspect of the present disclosure with the panel walls in the upright position;

FIG. 9 is a perspective view of a locking mechanism of the mobile, adjustable platform shown in circle C in FIG. 8 with the panel walls in the upright position;

FIG. 10 is a cross-sectional view of the locking mechanism of the mobile, adjustable platform shown along line A-A in FIG. 8;

FIG. 11 is a perspective view of the locking mechanism of the mobile, adjustable platform shown in circle C in FIG. 8 with the panel walls in the downward position; and

FIG. 12 is a perspective view of the mobile, adjustable platform of FIG. 8 with the panel walls in the downward position.

### DETAILED DESCRIPTION OF THE DISCLOSURE

For purposes of the description hereinafter, the terms “upper”, “lower”, “right”, “left”, “vertical”, “horizontal”, “top”, “bottom”, “lateral”, “longitudinal”, and derivatives thereof shall relate to the disclosure as it is oriented in the figures. However, it is to be understood that the disclosure may assume alternative variations and step sequences, except where expressly specified to the contrary. It is also to be understood that the specific devices and processes illustrated in the attached drawings and described in the following specification are simply exemplary aspects of the disclosure. Hence, specific dimensions and other physical characteristics related to the aspects disclosed herein are not to be considered as limiting.

The present disclosure is directed to, in general, a mobile platform 10. Throughout the application, the mobile platform will be labeled with element number 10; however, the mobile platform 10 may be paired with various accessories that together will generally be referred to as a mobile platform. It is also to be understood that the present disclosure is
directed to carriers, carts, and other storage containers that include a portable wheel arrangement and moveable panels to assist in a user easily moving these carriers, carts, and storage containers across open terrain with a desired surface area so that the desired materials can be transported. The carriers, carts, and storage containers may include garden carts, hunting carts, construction carts and storage containers, and toy storage containers, among others.

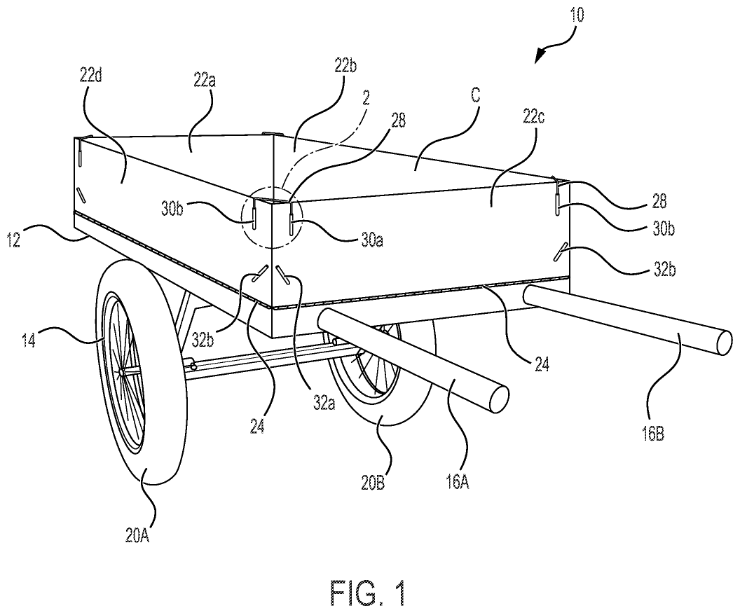

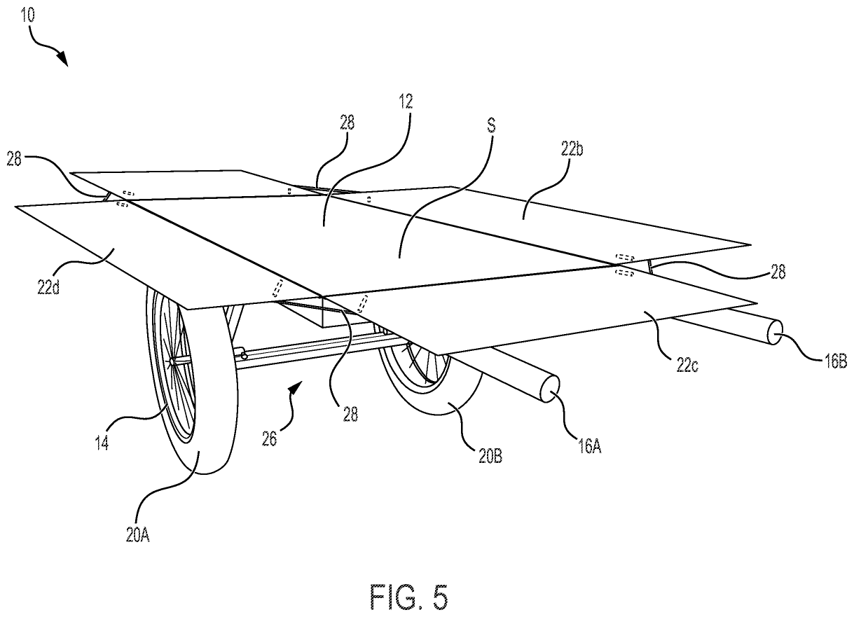

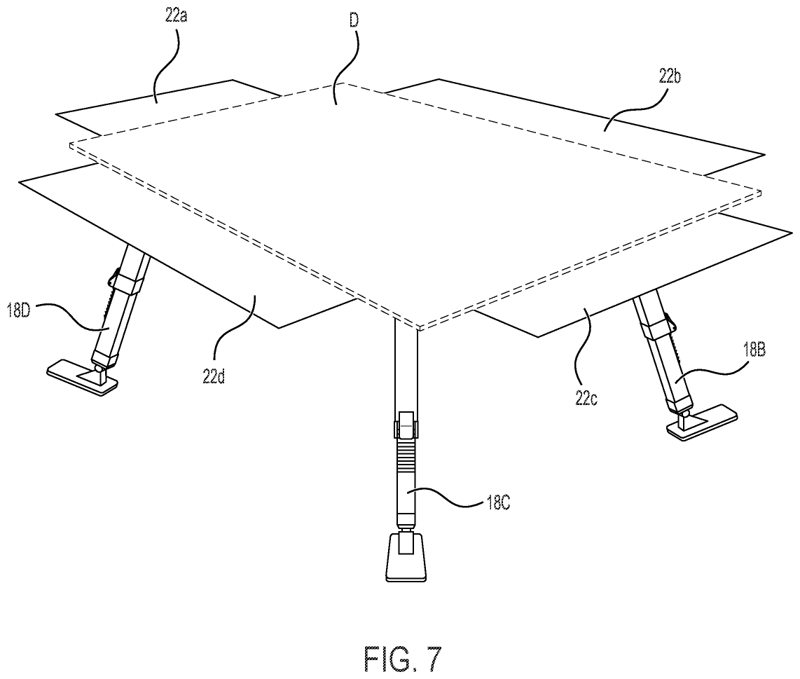

Referring to FIGS. 1-6, the mobile platform 10 according to one aspect or embodiment is shown in a transport position. The mobile platform 10 includes a base 12 that will ultimately be used to create a workspace or to define a support surface on which various construction, hunting, gardening, and other activities that require tools or equipment can be conducted. Extending from the base 12 is a wheel arrangement 14 and handles 16A, 16B. Adjustable support members or adjustable support legs 18 are folded within the base 12, meaning the adjustable support legs 18 are not visible in FIGS. 1, 5, and 6. The adjustable support legs 18 are unfolded and used to support the base 12 as discussed below and shown in FIG. 7. In the transport position, the mobile platform 10 is supported by wheels 20A, 20B of the wheel arrangement 14, and handles 16A, 16B are attached to and extend from an edge of the base 12. In this configuration, an individual can grip the handles 16A, 16B and roll the mobile platform 10 across various terrains so that it can be set up at different locations. While only two poles are shown as the handles 16A, 16B, it is understood that the handles 16A, 16B may take any shape that allows a user to roll the mobile platform 10 across a terrain. The handles 16A, 16B may also be attached to any side of the mobile platform 10. The handles 16A, 16B may be detachable from the base 12. To attach and detach the handles 16A, 16B, the handles 16A, 16B may have a threaded end that corresponds to a threaded hole within the base 12. A frictional fit between the handles 16A, 16B and holes in the base 12 may also be used.

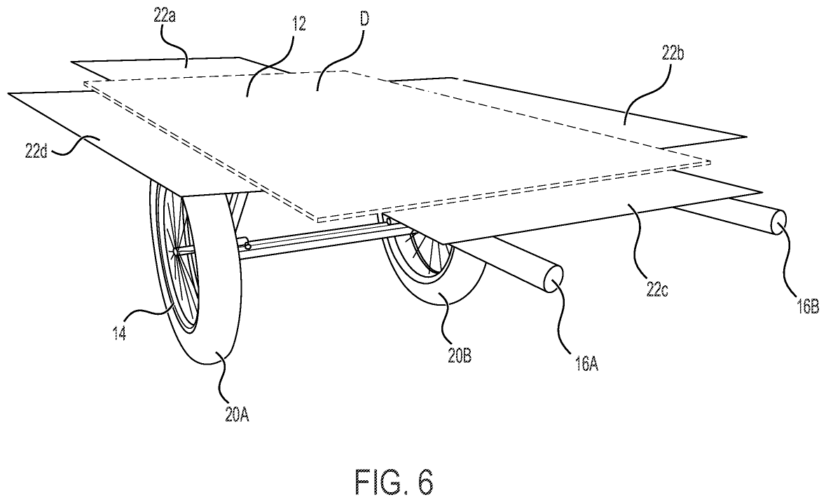

Referring to FIG. 7, the mobile platform 10 is shown in a support position. In the support position, the handles 16A, 16B and wheel arrangement 14 are removed from the base 12, the base 12 is unfolded, the adjustable supports 18A, 18B, 18C, 18D are unfolded and then extended from the base 12 in order to support the base 12 on the ground surface. The ground surface may include even terrain or uneven terrain, yet the adjustable supports 18A, 18B, 18C, 18D ensure that the mobile platform 10 remains level and supported. The complete arrangement and functionality of the features discussed in this paragraph, including the transition between a rolling position (shown in FIGS. 1 and 6) and a support position (shown in FIG. 7) are described in PCT/US2022/12670, which is incorporated by reference herein in its entirety. Additional features that can be used with the mobile platform 10 are described in U.S. patent application Ser. No. 17/235,550, U.S. Pat. No. 11,006,625, and U.S. Pat. No. 10,645,920, the discloses of which are hereby incorporated by reference in their entireties.

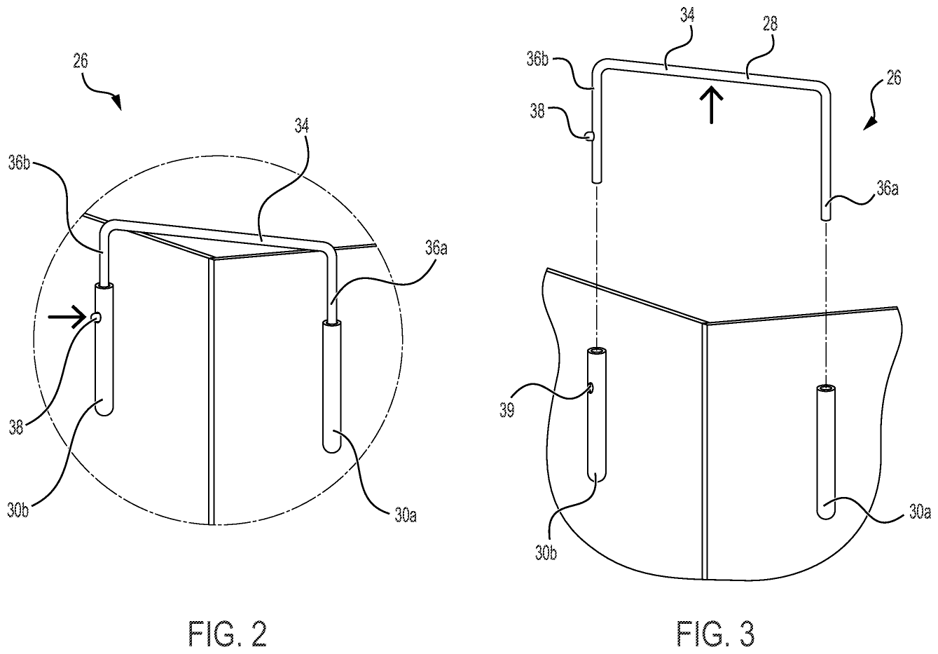

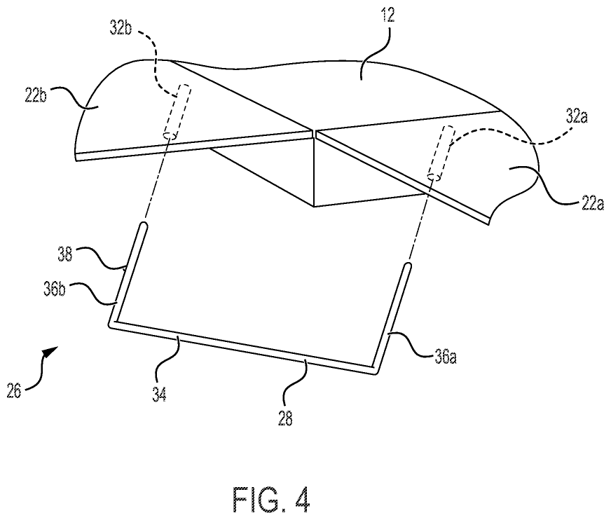

With continued reference to FIGS. 1-7, the mobile platform 10 includes panels 22a, 22b, 22c, 22d extending along the edges of the base 12. The panels 22a, 22b, 22c, 22d are connected to the base 12 by hinges 24 that also extend along the edges of the platform 12 with the panels 22a, 22b, 22c, 22d. The hinges 24 allow the panels 22a, 22b, 22c, 22d to move between an upright position, shown in FIGS. 1 and 2, and a downward position, shown in FIGS. 4-7. In the upright position, the panels 22a, 22b, 22c, 22d define a storage space C with the base 12 permitting various tools and equipment to be held by and moved with the mobile platform 10 within the space C. In the downward position, the panels 22a, 22b, 22c, 22d and base 12 define a storage surface S. In the downward position, the panels 22a, 22b, 22c, 22d serve as an extension of the base to permit the transport of materials that are longer or wider than the surface of the base 12, such as drywall D, as is shown in FIGS. 6 and 7. In other words, the panels 22a, 22b, 22c, 22d create a larger surface area for transport and work when placed in the downward position as compared to the upright position.

To hold the panels 22a, 22b, 22c, 22d in either the upright position or the downward position, a locking mechanism 26 is used. The locking mechanism 26 includes a locking bracket 28 and pairs of slots 30a, 30b, 32a, 32b. The first pair of slots 30a, 30b are used to lock the panels 22a, 22b, 22c, 22d in the upright position, while the second pair of slots 32a, 32b are used to lock the panels 22a, 22b, 22c, 22d in the downward position. Both pairs of slots 30, 32 are arranged to receive the locking bracket 28 therein and function in a similar manner.

As shown in FIGS. 1-5, the locking bracket 28 is generally U-shaped, although other suitable shapes may be contemplated. The locking bracket 28 includes a bar 34 with extensions 36a, 36b protruding outwardly from each end of the bar 34. The extensions 36a, 36b extend parallel to one another in the same direction relative to the bar 34. In the upright position, extension 36a is received within slot 30a, and extension 36b is received within slot 30b. In the downward position, extension 36a is received within slot 32a, and extension 36b is received within slot 32b.

In order to lock the panels 22a, 22b, 22c, 22d in their desired positions, the pairs of slots 30a, 30b, 32a, 32b are located on adjacent panels 22a, 22b, 22c, 22d and separated from each other by a length equal to the length of the bar 34. For example, as shown in FIG. 1, in the upright position, slot 30a may be located on panel 22c proximate an end point of panel 22c, and slot 30b may be located on panel 22d proximate the end point of panel 22d that is nearest panel 22c. When viewed from the top, the distances between the slots 30a, 30b and the nearest end points of their respective panels 22c, 22d define a right triangle having a hypotenuse that is equal to the length of the bar 34 of the locking bracket 28. In the downward position, slot 32a may be located on panel 22c proximate an end point of panel 22c, and slot 32b may be located on panel 22d proximate an end point of panel 22d nearest panel 22c. As a result of the fixed nature of the locking bracket 28 and the hinged movement of the panels 22a, 22b, 22c, 22d when changing from the upright position to the downward position and vice versa, the pairs of slots 30a, 30b, 32a, 32b are arranged angled relative to one another. In other words, while a single pair of slots 30a, 30b may be parallel to one another, that single pair of slots 30a, 30b are angled relative to the other pair of slots 32a, 32b and vice versa. While the arrangement of the slots 30a, 30b, 32a, 32b are discussed in relation to panels 22c, 22d, the same slot-panel arrangements are present at each corner of the platform 10.

To ensure that the locking bracket remains within the slots 30a, 30b, 32a, 32b, one extension 36B may include a detent 38 that sticks outward and can secure the locking bracket 28 within the slots 30a, 30b, 32a, 32b. The detent 38 can be pushed into the extension 36b when the locking bracket 28 is slid into the slots 30a, 30b, 32a, 32b. One of each of the pairs of slots 30b, 32b can include a receiving key 39 that is essentially a hole to allow for the detent 38 to extend outward after the locking bracket 28 has slid a certain distance within the slots 30a, 30b, 32a, 32b, thereby locking the locking bracket 28 within the pairs 30a, 30b, 32a, 32b of slots. To remove the locking bracket 28, the detent 38 can be pushed inward and out of the key 39 to permit a user to grab the bar 34 and pull the locking bracket 28 out of its respective slots 30a, 30b, 32a, 32b.

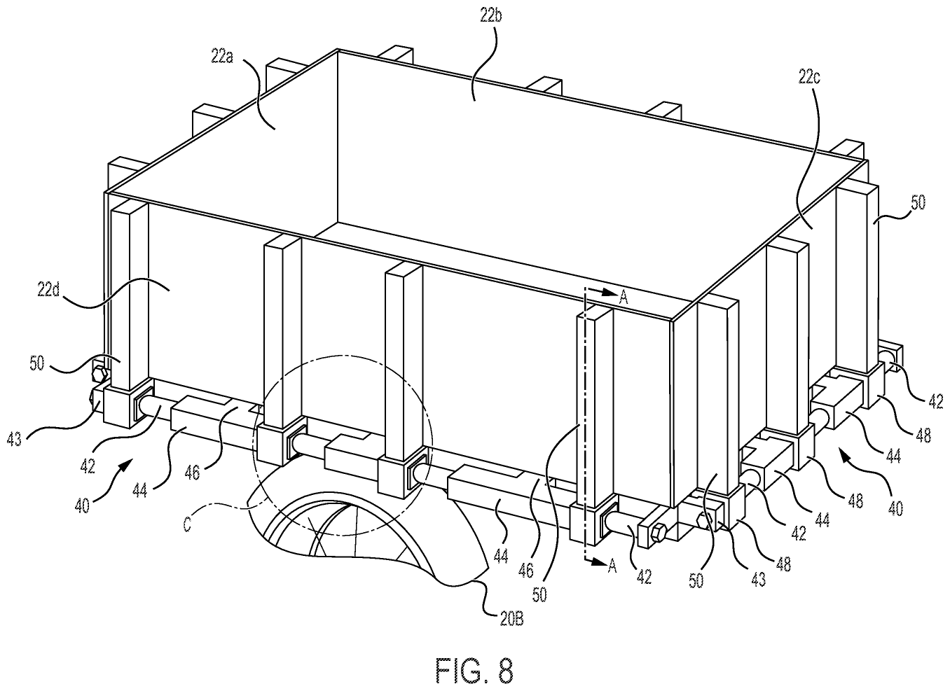

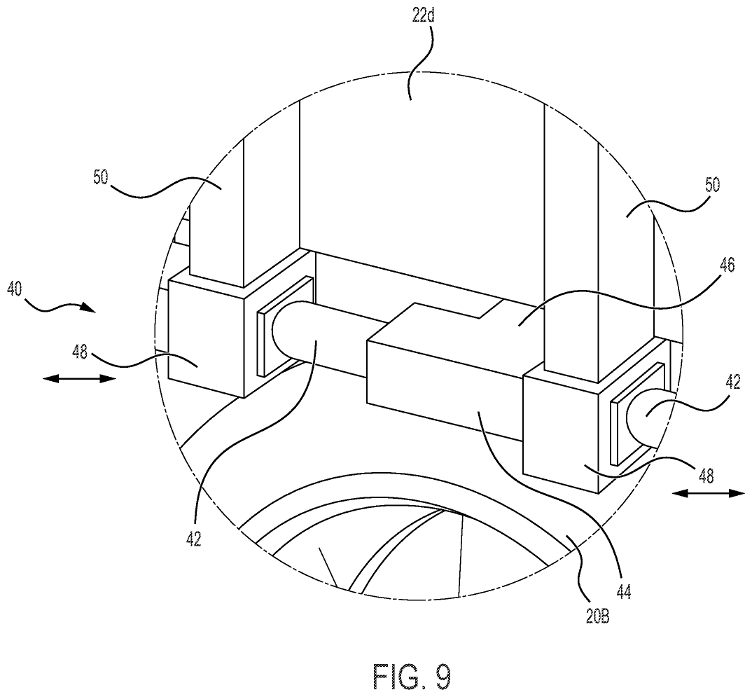

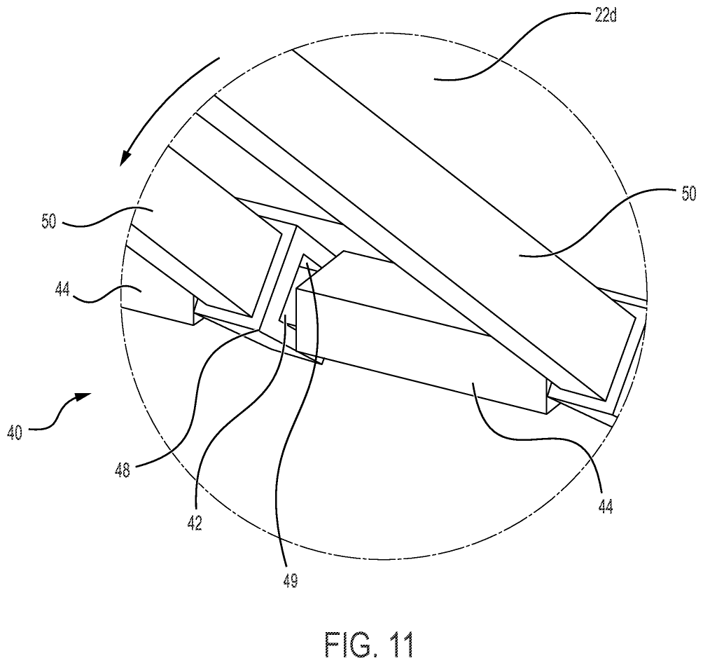

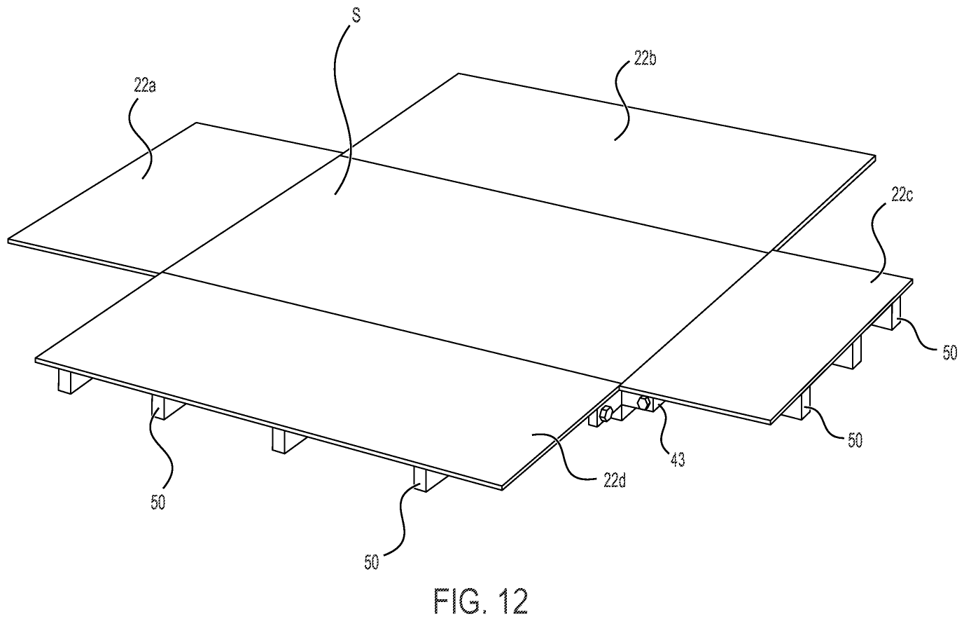

With reference to FIGS. 8-12, another locking mechanism 40 for the panels 22a, 22b, 22c, 22d about the base 12 of the mobile platform 10 is shown. Each locking mechanism 40 is used in connection with one panel 22a, 22b, 22c, 22d, so only one representative locking mechanism 40 will be discussed herein. The locking mechanism 40 acts like a hinge, so the hinges 24 described in the first embodiment are not needed for the panels 22a, 22b, 22c, 22d. The locking mechanism includes a rod 42 extending along the length of each side of the base 12. The rod 42 is also located a distance away from the base 12. The rod 42 is mounted to end pieces 43 that are attached to and extending away from the ends of the side of the base 12 along which the rod 42 extends. The rod 42 can be mounted to the end pieces 43 via a bracket and bolt or other connection mechanism known to those having skill in the art. As shown, the rod 42 is cylindrical, but it may take other shapes, such as a quadrilateral having a square or rectangular cross section, so long as it permits the same functionality within the locking mechanism 40 as is about to be described.

The locking mechanism also includes a plurality of tubes 44 fit about the rod 42 and connected to the base 12 via connectors 46. As shown, the tubes 44 are quadrilateral, but other shapes, such as a cylinder, may be used. The connectors 46 can be welded to the base 12 and quadrilateral tubes 44 or connected via other methods known to those having skill in the art. It is also contemplated that the quadrilateral tubes 44 can engage in a frictional fit with the rod 42 and eliminate the need for the connectors 46. The tubes 44 are spaced along the rod 42 so that parts of the rod 42 are exposed. As shown, four tubes 44 are located within the locking mechanism mechanisms 40 along the long sides of the base 12, and two tubes 44 are used in the locking mechanisms 40 along the short sides of the base 12; however, more or fewer quadrilateral tubes 44 may be used depending on the size of the base 12 or depending on what is desired by a user.

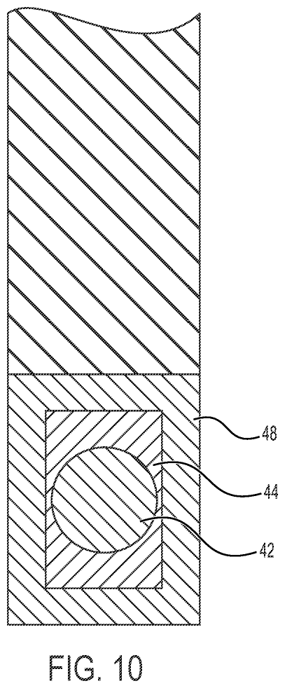

The locking mechanism also includes a plurality of base members 48 that have a hollow interior 49, so that the base members 48 fit about and encompass one or both of the rod 42 and the tubes 44, receiving one or both elements within the hollow interior 49. The hollow interior 49 is sized so that the base members 48 can slide freely along the rod 42, along the length of the base 12, and engage in a frictional fit with the tubes 44. In this frictional fit, an inner surface of the base member 48, located within the hollow interior 49, slides laterally against an outer surface of the tube 44. The lateral movement is symbolically shown with the double-sided arrows below element numbers 48 in the figures. Extending from the base members 48 are stanchions 50. The panels 22a, 22b, 22c, 22d extend between and are supported by the stanchions 50. The frictional fit it between the base member 48 and the quadrilateral tubes 44 creates the locking effect that secures the panels 22a, 22b, 22c, 22d in the upright or the downward positions. Tan example of this frictional fit and the engagement between the base member 48, tube 44 and rod 42 can be seen in FIG. 10.

To change the panels 22a, 22b, 22c, 22d from the upright position to the downward position, the base members 48 are pushed away from the quadrilateral tubes 44 with which they are engaged. The base members 48 then slide along the rod 42 until the base members 48 only encompass the exposed portions of the rod 42. By encompassing only the exposed portions of the rod 42, the base members 48 can rotate ninety degrees from the upward position to the downward position. From this position, the base member 48 can then slide back along the rod 42 in the direction of the quadrilateral tube 44, where the base member 48 will again frictionally engage the quadrilateral tube 44, locking it in place. To reposition the panels 22a, 22b, 22c, 22d in the upright position, the opposite movements are undertaken. The number of base members 48 can be equal to or less than the number of quadrilateral tubes 44 to facilitate the lateral sliding of the locking mechanism 40 about the telescoped rod 42 and quadrilateral tubes 44.

The mobile platform 10 and the features described above can be used in a variety of applications. It is contemplated that the base 12 with an engaged wheel arrangement 14 can be attached to a bicycle, e-bike, motorcycle, ATV, or other vehicle to facilitate transport. The mobile platform 10 can be carried behind the vehicle, transported as a sidecar, or pushed using a device the same or similar to a walk-behind unit. The detachable handles 16A, 16B can be connected to these vehicles, or they can be detached and replaced with a connection mechanism. The operation and attachment can be undertaken in a variety of ways.

By connecting the mobile platform 10 in the manner described above, police or emergency services can transport mobile platforms 10 over various terrains to the scene of an accident, crime, or a staging area nearby. One or more mobile platforms 10 can provide portable level surfaces on which police or other emergency personnel can conduct work. The mobile platform 10 may even include storage spaces, such as lock boxes, that would allow emergency personnel to temporarily leave the mobile platforms 10 for whatever reason without fear of losing important items staged on the mobile platforms 10.

While various aspects of the mobile platform 10 were provided in the foregoing description, those skilled in the art may make modifications and alterations to these aspects without departing from the scope and spirit of the invention. For example, it is to be understood that this disclosure contemplates that, to the extent possible, one or more features of any aspect can be combined with one or more features of any other aspect. Accordingly, the foregoing description is intended to be illustrative rather than restrictive. The invention described hereinabove is defined by the appended claims, and all changes to the invention that fall within the meaning and the range of equivalency of the claims are to be embraced within their scope.

The invention claimed is:

1. A mobile platform comprising:
a base member;
at least one wheel arrangement comprising at least one wheel, the at least one wheel arrangement detachably mounted to the base member;
a plurality of panels extending about the base member; and
at least one locking mechanism,
wherein the plurality of panels are transitionable relative to the base member between an upright position and an unfolded position, and
wherein the at least one locking mechanism is configured to lock the plurality of panels in the upright position and the unfolded position.

2. The mobile platform of claim 1, wherein the plurality of panels and the base member define a storage surface area, and
wherein, when the panels are in the upright position, the storage surface area is smaller than when the panels are in the unfolded position.

3. The mobile platform of claim 1, wherein, when the plurality of panels are in the upright position, the plurality of panels and the base member define a storage volume.

4. The mobile platform of claim 1, wherein the at least one locking mechanism comprises at least one locking bracket and a plurality of receiving slots located on an outer surface of the plurality of panels, the plurality of receiving slots being configured to receive the at least one locking bracket therein.

5. The mobile platform of claim 4, wherein the plurality of receiving slots comprise a first pair of receiving slots and a second pair of receiving slots,
wherein the first pair of receiving slots are configured to receive the at least one locking bracket when the panels are in the upright position, and
wherein the second pair of receiving slots are configured to receive the at least one locking bracket when the panels are in the unfolded position.

6. The mobile platform of claim 5, wherein a first receiving slot of the first pair of receiving slots is located on a first panel, and a second receiving slot of the first pair of receiving slots is located on a second panel adjacent to the first panel.

7. The mobile platform of claim 6, wherein a first receiving slot of the second pair of receiving slots is located on the first panel below the first receiving slot of the first pair of receiving slots, and the second receiving slot of the second pair of receiving slots is located on the second panel below the second receiving slot of the first pair of receiving slots.

8. The mobile platform of claim 7, wherein the plurality of panels comprises four panels and the at least one bracket comprises four brackets,
wherein each of the four panels include the first receiving slot of the first pair of receiving slots and the first receiving slot of the second pair of receiving slots proximate a first end of the panel and the second receiving slot of the first pair of receiving slots and the second receiving slot of the second pair of receiving slots proximate a second end of the panel, the second end located opposite the first end, and
wherein each of the brackets are configured to be received in the first pair of receiving slots or the second pair of receiving slots located on adjacent panels.

9. The mobile platform of claim 5, wherein the at least one locking bracket comprises a bar, first leg extending from a first end of the bar, and a second leg extending from a second end of the bar opposite the first end, and
wherein the first leg and the second leg are configured to be received within corresponding receiving slots of the first and second pairs of receiving slots.

10. The mobile platform of claim 5, wherein the at least one locking bracket comprises a detent and one of the first pair of receiving slots and one of the second pair of receiving slots each comprise a key configured to engage with the detent to lock the panels in the upright position or the unfolded position.

11. The mobile platform of claim 1, wherein the at least one locking mechanism comprises:
at least one tube extending along a portion of the length of the panel;
at least one base member connected to a panel and slidable along a length of the panel and a length of the at least one tube, the at least one base member being rotatable so that the panel can move between the upright position and the unfolded position, and
wherein the at least one base member is configured to frictionally engage with the at least one tube, so that when the at least one base member is frictionally engaged with the at least one tube, the panel is locked in the upright position or the unfolded position, and when the at least one base member is not frictionally engaged with the at least one tube, the at least one base member is rotatable so that the panel can move between the upright position and the unfolded position.

12. The mobile platform of claim 11, wherein the at least one locking mechanism further comprises a rod extending along the length of the panel,
wherein the at least one tube extends about a portion of the rod,
wherein the at least one base member is slidable along the rod and the at least one tube.

13. The mobile platform of claim 12, wherein the at least one tube comprises a plurality of tubes, each extending about a portion of the rod,
wherein the at least one base member comprises a plurality of base members, each corresponding to one of the plurality of tubes.

14. The mobile platform of claim 13, wherein one locking mechanism is provided for each of the plurality of panels.

15. The mobile platform of claim 11, wherein the rod and at least one tube share an axis extending along the length of the panel.

16. The mobile platform of claim 15, wherein the portion of the at least one base member that is configured to frictionally engage with the at least one tube shares the axis with the rod and the at least one tube.

17. The mobile platform of claim 11, wherein the at least one base member comprises a stanchion extending perpendicular from the at least one tube and connected to the panel.

18. The mobile platform of claim 11, wherein the at least one tube comprises a connector configured to connect the at least one tube to the base.

19. The mobile platform of claim 12, further comprising end pieces extending from the base,
wherein the rod extends between the end pieces.

20. The mobile platform of claim 19, wherein the end pieces extend from opposing ends of the base.
